(19) United States
(12) Patent Application Publication
(10) Pub. No.: US 2009/0112507 A1
(43) Pub. Date: Apr. 30, 2009

(54) FLUID PROBE

(76) Inventors: Daniel B. Edney, Irvine, CA (US); James Ryan Yates, Mission Viejo, CA (US)

Correspondence Address: KAUTH , POMEROY , PECK & BAILEY ,LLP, P.O. BOX 19152, IRVINE, CA, 92623, US

(21) Appl. No.: 11/957,867

(22) Filed: Dec. 17, 2007

Related U.S. Application Data
(60) Provisional application No. 60/983,416, filed on Oct. 29, 2007.

(51) Int. Cl. G01K 7/00; G01N 25/18

(52) U.S. Cl. 702/136; 374/44; 374/179; 374/E07.001

(57) ABSTRACT

Systems and methods for evaluating the properties of fluids are described. One embodiment of the invention includes a printed wiring board substrate on which a first conductivity sensor and a second conductivity sensor are located, a temperature sensor mounted on the printed wiring board substrate and a casing partially encapsulating the printed wiring board substrate so as to leave at least the first and second conductivity sensors exposed.

### CROSS REFERENCE TO RELATED APPLICATION

This application claims priority to Provisional Application No. 60/983,416 filed Oct. 29, 2007, the disclosure of which is incorporated herein by reference.

### BACKGROUND

The present invention relates generally to fluid probes and more specifically to fluid probes capable of detecting changes in the properties of a fluid.

Mechanical systems often require lubricants to protect mechanical components from wear during operation. Over time and with use the lubricants in a mechanical system deteriorate and become less effective. Use of a deteriorated lubricant can increase mechanical wear and decrease the useful lifetime of a mechanical system. Ideally, lubricants are replaced immediately prior to deterioration.

Dipsticks are commonly used to evaluate fluids within a tank. For example, a dipstick can be used to measure oil levels in the engine pan of an engine. In many applications, the dipstick is inserted into an opening in the tank and removed to obtain a sample that reveals information concerning the fluid within the tank. In other applications, the dipstick can include a sensor that generates an electric signal indicative of a characteristic of the fluid.

### SUMMARY OF THE INVENTION

Systems and methods are described for evaluating the characteristics of fluids. In many embodiments, the characteristics of lubricants are evaluated by comparing the conductivity of the lubricants over time with known characteristics indicative of the degradation of the lubricant. One embodiment of the invention includes a printed wiring board substrate on which a first conductivity sensor and a second conductivity sensor are located, a temperature sensor mounted on the printed wiring board substrate and a casing partially encapsulating the printed wiring board substrate so as to leave at least the first and second conductivity sensors exposed.

In a further embodiment, the first and second conductivity sensors each include a pair of electrodes.

In another embodiment, the spacing of each pair of electrodes is different.

In a still further embodiment, each pair of electrodes is an interdigitated pair of electrodes.

In still another embodiment, the first conductivity sensor and the second conductivity sensor are located on opposite sides of the printed wiring board substrate.

In a yet further embodiment, the temperature sensor is a thermistor.

In yet another embodiment, the temperature sensor is a thermocouple.

In a further embodiment again, the diameter of the fluid probe is less than 0.35 inches.

In another embodiment again, the first and second conductivity sensors are located in different positions along the length of the printed wiring board substrate.

A further additional embodiment includes a fluid probe, where the fluid probe includes a first conductivity sensor, a second conductivity sensor and a temperature sensor, signal processing circuitry that receives inputs from the conductivity sensors and the temperature sensor, a microprocessor configured to receive a pair of current measurements and a temperature measurement from the signal processing circuitry and an output device configured to receive signals from the microprocessor.

In another additional embodiment, the microprocessor is further configured to determine information concerning the fluid using the conductivity measurements and the temperature measurement.

In a still yet further embodiment, the microprocessor is further configured to apply a temperature correction to the conductivity measurement.

In still yet another embodiment, the microprocessor is further configured to smooth the corrected conductivity measurements.

In a still further embodiment again, the microprocessor is configured to compare the corrected conductivity measurements over time to a set of characteristics known to be indicative of the deterioration of the fluid.

In still another embodiment again, the microprocessor is configured to compare the corrected conductivity measurements over time to a Kauffman curve.

In a still further additional embodiment, the microprocessor is configured to compare the conductivity measurements of the first and second conductivity sensors.

In still another additional embodiment, the first conductivity sensor has a larger pitch than the second conductivity sensor and the microprocessor is configured to detect contamination within a fluid by detecting when the ratio of the conductivity measurement of the second conductivity sensor relative to the conductivity measurement of the first conductivity sensor changes.

In a yet further embodiment again, the second conductivity sensor is located higher on the fluid probe than the first conductivity sensor and the microprocessor is configured to determine the level of the fluid by comparing the conductivity measurements of the first conductivity sensor and the second conductivity sensor.

Yet another additional embodiment includes a fluid probe including a conductivity sensor, and signal processing circuitry configured to provide an output from the conductivity sensor to a microprocessor. In addition, the microprocessor is configured to track conductivity measurements over time and to compare the tracked conductivity measurements to information concerning the predetermined conductivity characteristics of a degrading lubricant, and the microprocessor is configured to generate an alert upon determining that the conductivity measurements indicate that the lubricant is degraded beyond a predetermined threshold.

In a further additional embodiment again, the fluid probe includes a temperature sensor and the signal processing circuitry is configured to provide an output of the temperature sensor to the microprocessor and the microprocessor is further configured to compensate the conductivity measurements based upon the temperature measurements.

In another additional embodiment again, the microprocessor is further configured to smooth the conductivity measurements.

In a still yet further embodiment again, the microprocessor is configured to compare the tracked conductivity measurements to a Kauffman curve.

Still yet another embodiment again includes measuring the conductivity of the lubricant, recording the conductivity measurements over time, inspecting the recorded conductivity measurements for predetermined characteristics that are indicative of lubricant deterioration over time, and determining that the lubricant has exceeded its useful lifetime when the predetermined set of characteristics have been observed in the recorded conductivity measurements.

A still further additional embodiment again also includes measuring temperature and compensating the measurement of conductivity for temperature prior to recording the temperature measurement.

Still another additional embodiment again also includes making conductivity measurements using two separate conductivity sensors, determining the ratio of the conductivity measurements of the two sensors and detecting contamination of the lubricant based upon a change in the ratio of the conductivity measurements of the two sensors.

Another further embodiment also includes making conductivity measurements from two separate conductivity sensors, comparing the conductivity measurements from two conductivity sensors and determining the level of the lubricant based upon the comparison.

In still another further embodiment, the predetermined characteristics include a period of decreasing conductivity followed by at least one turning point.

### BRIEF DESCRIPTION OF THE DRAWINGS

FIG. 1 is a semi-schematic circuit diagram of a fluid sensing system in accordance with an embodiment of the invention.

FIG. 2 is an isotropic view of a fluid probe in accordance with an embodiment of the invention.

FIGS. 3a and 3b are a top and bottom view of a printed wiring board connected to a cable, where the printed wiring board includes two conductivity sensors and a thermistor in accordance with an embodiment of the invention.

FIG. 4 is a top view of a printed wiring board connected to a cable, where the printed wiring board includes two conductivity sensors displaced along the Length of the printed wiring board in accordance with an embodiment of the invention.

FIGS. 5a-5c are semi-schematic circuit diagrams of sensing circuitry configured to be connected to a conductivity sensor in accordance with embodiments of the invention.

FIGS. 6a and 6b are semi-schematic circuit diagrams of circuitry including a waveform generator, a conductivity sensor and a current to voltage converter in accordance with embodiments of the invention.

FIG. 7 is a flow chart illustrating a process for evaluating the quality of a Lubricant in accordance with an embodiment of the invention.

FIG. 8 is a chart showing a curve showing the characteristics of the conductivity of oiL based lubricants as the oiL based Lubricants deteriorate over time.

### DETAILED DESCRIPTION OF THE INVENTION

Turning now to the drawings, embodiments of fluid sensing systems are shown. In many embodiments, the fluid sensing systems include a fluid probe containing a number of sensors. The fluid probe is connected to sensing circuitry that provides an input signal to a microprocessor. In several embodiments, the fluid probe includes a pair of conductivity sensors and a temperature sensor. In a number of embodiments, the sensors are formed on a printed circuit board that is protected by a casing. The casing is elongated and connected to a cable, where the casing and the cable are configured to be inserted in a similar fashion to a dipstick. In many embodiments, the fluid probe is used as a replacement for a conventional dipstick in a mechanical system such as an engine and the fluid probe is used to detect deterioration in lubricant oil in the engine's oil pan.

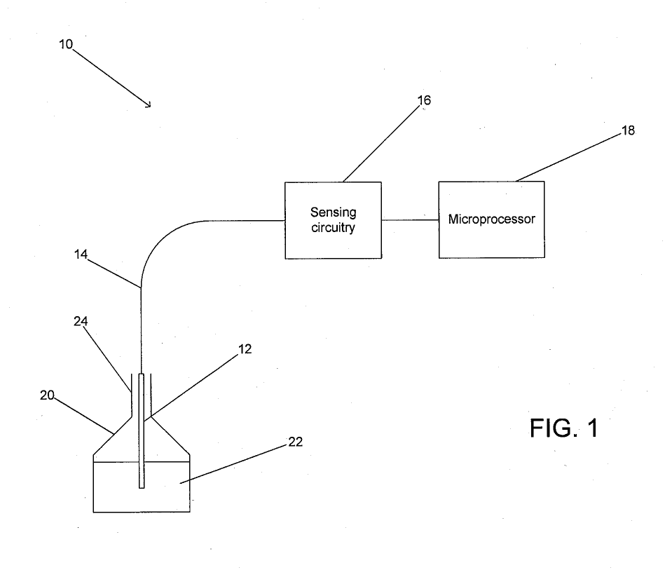

A fluid sensing system in accordance with an embodiment of the invention is shown in FIG. 1. The fluid sensing system 10 includes a fluid probe 12 connected via a cable to sensing circuitry 16. The sensing circuitry 16 is connected to a microprocessor 18. The fluid probe 12 of the fluid sensing system 10 is inserted in a vessel 20 that contains a fluid 22. In the illustrated embodiment, the vessel has a narrow neck 24 opening and the fluid probe is elongated for insertion into the opening.

The fluid probe 12 contains sensors that are capable of detecting physical properties of the fluid. Power and any driving signals required for the sensors to function are provided by the sensing circuitry 16. The sensing circuitry 16 also receives the sensor outputs and provides signals to the microprocessor indicative of the sensor outputs.

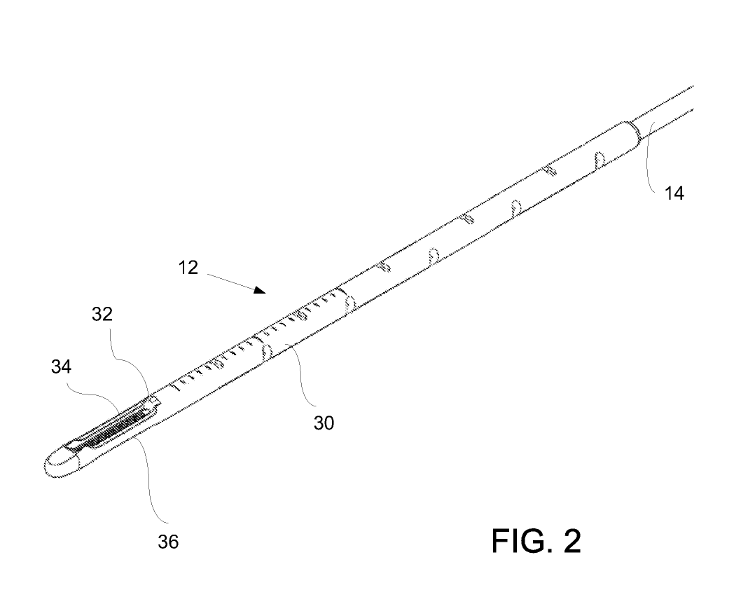

A fluid probe connected to a cable in accordance with an embodiment of the invention is shown in FIG. 2. The fluid probe 12 includes a casing 30 that incorporates a number of openings that expose internal components of the fluid probe. A first opening 32 in the casing reveals a printed wiring board 34 on which a first conductivity sensor is formed. The conductivity sensor includes a pair of interdigitated electrodes in the form of circuit traces on a printed wiring board substrate. A second opening 36, which is partially obscured, reveals a second conductivity sensor formed on the opposite surface of the printed wiring board 34 to the surface on which the first conductivity sensor is formed.

The casing 30 surrounding the fluid probe is typically non-conductive so as to avoid interference with sensors included on the fluid probe. In many embodiments, the casing is constructed from an oil-resistant material such as, but not limited to, Nylon, Fluorinated Ethylene Propylene (FEP) or Nitrile. In a number of embodiments, the casing is over molded onto the internal components of the fluid probe and, in many embodiments, a portion of the cable as well. In several embodiments, the internal components of the fluid probe are inserted into the casing and secured using an encapsulant. In the illustrated embodiment the casing only encloses the fluid probe, in many embodiments the casing encapsulates a portion of the cable in addition to the fluid probe. The casing typically increases the rigidity of the fluid probe. Therefore, encapsulating a portion of the cable can both protect the cable and assist with the insertion of the fluid probe and cable into narrow openings. In embodiments where the fluid probe is intended to replace a dipstick in an engine, the outer diameter of the casing is typically less than 0.25″ and the fluid probe has a bend radius of less than 4″. In several embodiments, the outer diameter is less than 0.35″. In other embodiments, other dimensions and rigidity can be selected in accordance with the application for which the fluid probe is intended.

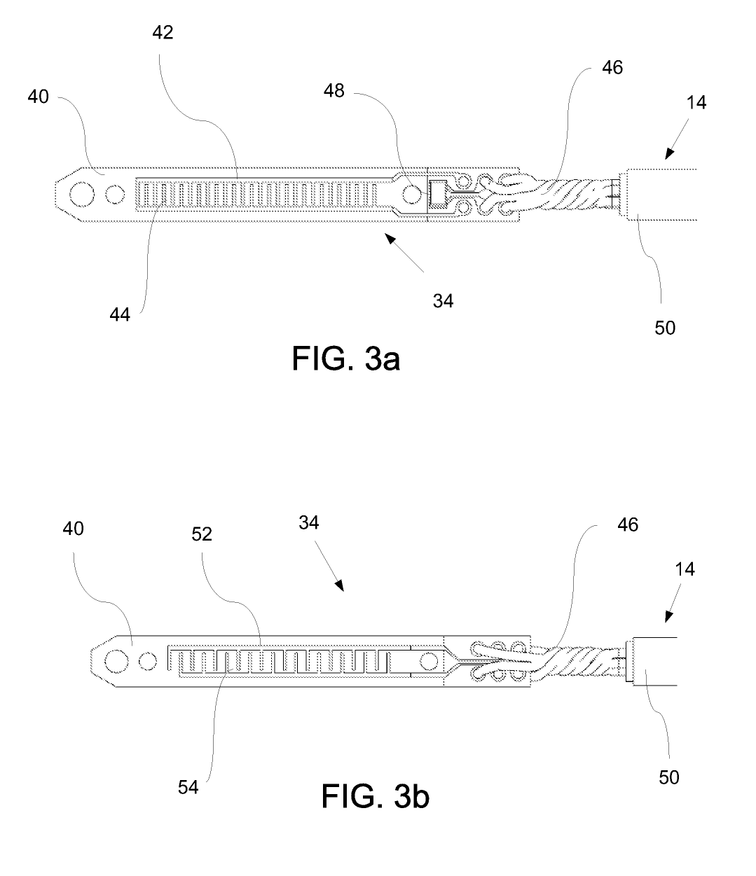

First and second conductivity sensors of a fluid probe in accordance with an embodiment of the invention are seen in more detail in FIGS. 3a and 3b, which are top and bottom views of a fluid probe without its casing. Turning first to FIG. 3a, the top surface of the printed wiring board 34 is shown. Patterned onto the printed wiring board substrate 40 is a pair of interdigitated electrodes 42, 44. The electrode pair forms a first conductivity sensor. The electrodes are connected to a pair of conductors 46 that are threaded through the sheath 50 of the cable 14. A thermistor 48 is also mounted on the surface of the printed wiring board substrate 40. The thermistor 48 can be used to measure the temperature of a fluid in which the fluid probe is immersed. The thermistor is also connected via circuit traces to a pair of conductors 48. The thermistor 48 can be contained within the fluid probe casing or exposed depending upon the response time and sensitivity required from the temperature measurements. In a number of embodiments, other types of temperature sensors can be used to obtain temperature measurements including, but not limited to, a thermocouple.

The bottom surface of the printed wiring board 34 is shown in FIG. 3b. The bottom surface also includes a pair of interdigitated electrodes 52, 54 patterned onto the printed wiring board substrate 40. The electrode pair forms a second conductivity sensor. The pitch of the interdigitated electrodes is much finer than that of the first conductivity sensor. In many applications, the first conductivity sensor is used to measure the conductivity of the bulk fluid in which the fluid probe is immersed and the second conductivity sensor is used to measure the electrical conductivity of particles in the fluid. In one embodiment, the electrodes of the first conductivity sensor have a pitch of 750 microns and the electrodes of the second conductivity sensor have a pitch of 80 microns. In several embodiments, the pitches of the electrodes of the first and second conductivity sensors are chosen in accordance with the properties of the fluid in which the fluid probe is intended to be immersed and the particles suspended in the fluid.

In many embodiments, the printed wiring board substrate is a rigid high temperature substrate such as a fiberglass reinforced FR4 or polyimide substrate and the electrodes are formed as circuit traces on the surfaces of the substrate using conventional processes. In several embodiments, the electrodes are formed by lithography using copper, an intermediate Nickel layer and then a gold plating. In a number of embodiments, the materials chosen for use in the construction of the printed wiring board substrate are determined based upon the environment in which the fluid probe is intended for use. The connection of the thermistor and the cables to the printed wiring board can be achieved in any of a variety of ways. In one embodiment the thermistor 48 is connected via soldering and the physical strength of the connection is increased by using an encapsulant or sealant. Soldering or welding in conjunction with the use of an encapsulant can also be used to connect the conductors 46 in the cable 14 to circuit traces on the printed wiring board 34. The thermistor used is typically rated to survive predicted fluid temperatures and temperatures during the over molding process. When a thermocouple is used, compatible cabling metal is incorporated into the design.

Although the first and second conductivity sensors described above are constructed using interdigitated electrodes, any of a variety of electrode configurations can be used to construct conductivity sensors in accordance with embodiments of the invention. For example, parallel line traces, parallel exposed wires, array traces and parallel mesh screens can all be used to construct conductivity sensors.

The fluid probes shown in FIGS. 2-3b have two conductivity sensors. In many embodiments, additional conductivity sensors are incorporated into the fluid probe to measure additional characteristics of the fluid. In addition, a fluid probe in accordance with an embodiment of the invention can include more than one temperature sensor. In several embodiments, the fluid probe includes at least one temperature sensor located to detect the temperature of the fluid in which the fluid probe is immersed and at least one temperature sensor located above the fluid to measure vapor temperatures.

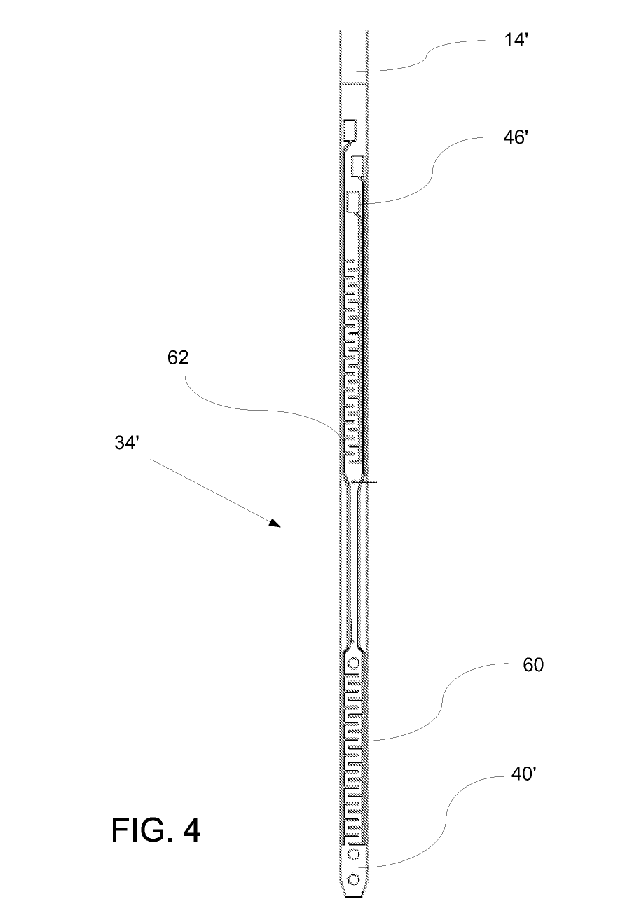

A fluid probe in accordance with an embodiment of the invention without a casing that includes a third conductivity sensor to detect fluid level is shown in FIG. 4. The fluid probe includes a printed wiring board 34′ that is connected to a plurality of conductors 46′ in a cable 14′. Two conductivity sensors are formed on the surface of the printed wiring board substrate 40′. The first conductivity sensor 60 is located proximate the end of the printed wiring board 34′ that is opposite the end to which the conductors 46′ are attached (i.e., the end that is first inserted into a fluid). The second conductivity sensor 62 is located proximate the end of the printed wiring board 34′ to which the conductors 46′ are attached. In operation, the fluid probe is inserted into a fluid and the first conductivity sensor 60 measures the conductivity of the fluid. The second conductivity sensor 62 is located at a height on the probe that results in the second conductivity sensor being partially immersed in the fluid. The ratio of the conductivity measurements between the first conductivity sensor 60 and the second conductivity sensor 62 can then be used to determine the level of the fluid in which the fluid probe is immersed.

In many embodiments, a fluid probe is connected to sensing circuitry by a cable. The nature of the cable depends upon the intended application. For example, a 6 core cable with an FEP jacket can be used with fluid probes in accordance with embodiments of the invention that are intended for use in engine oil monitoring applications. In many embodiments, the cable shield is grounded to a vehicle chassis or to a ground, which is established either via the power connection or the sensing electrodes. The connection between the probe and the sensing electronics can be hard wired or can be via a connector. In many embodiments, a weather resistant connector is used to enable separation of the fluid probe from the sensing electronics during installation and maintenance.

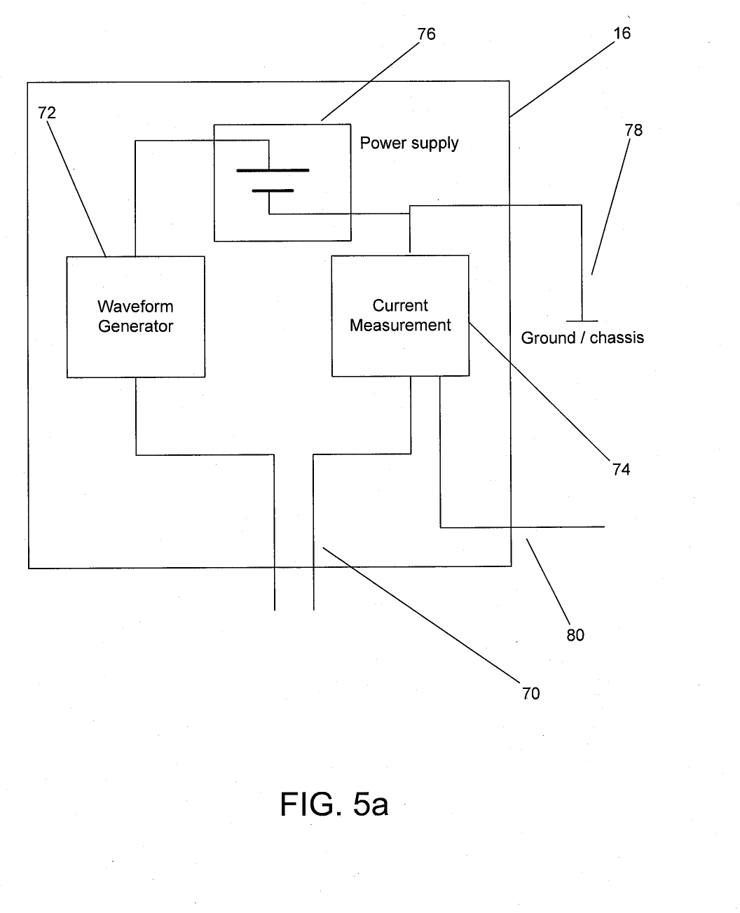

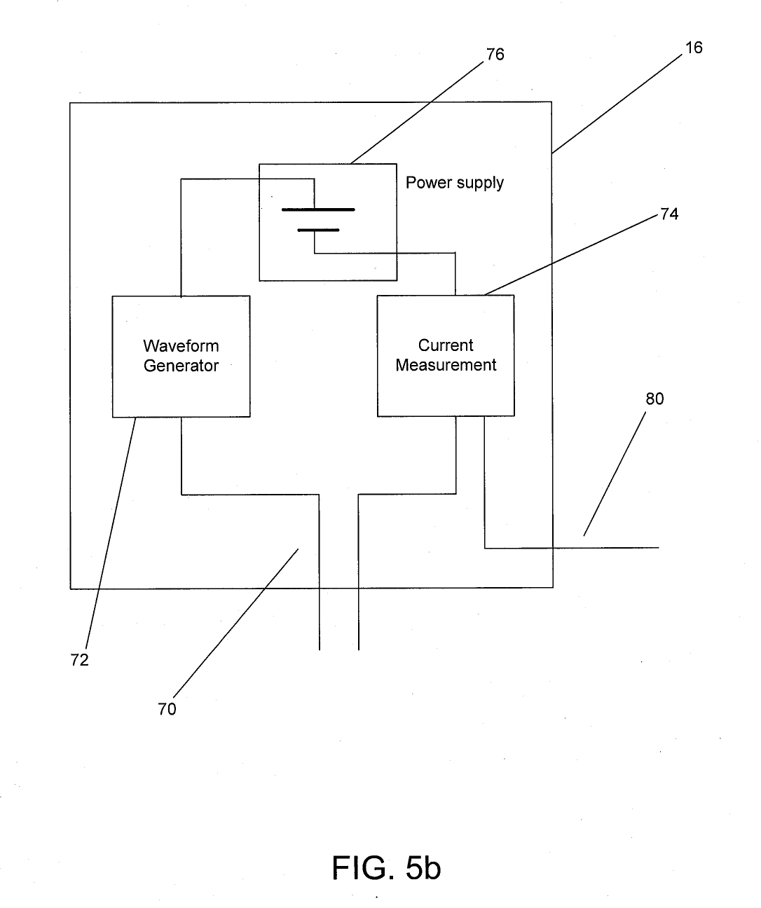

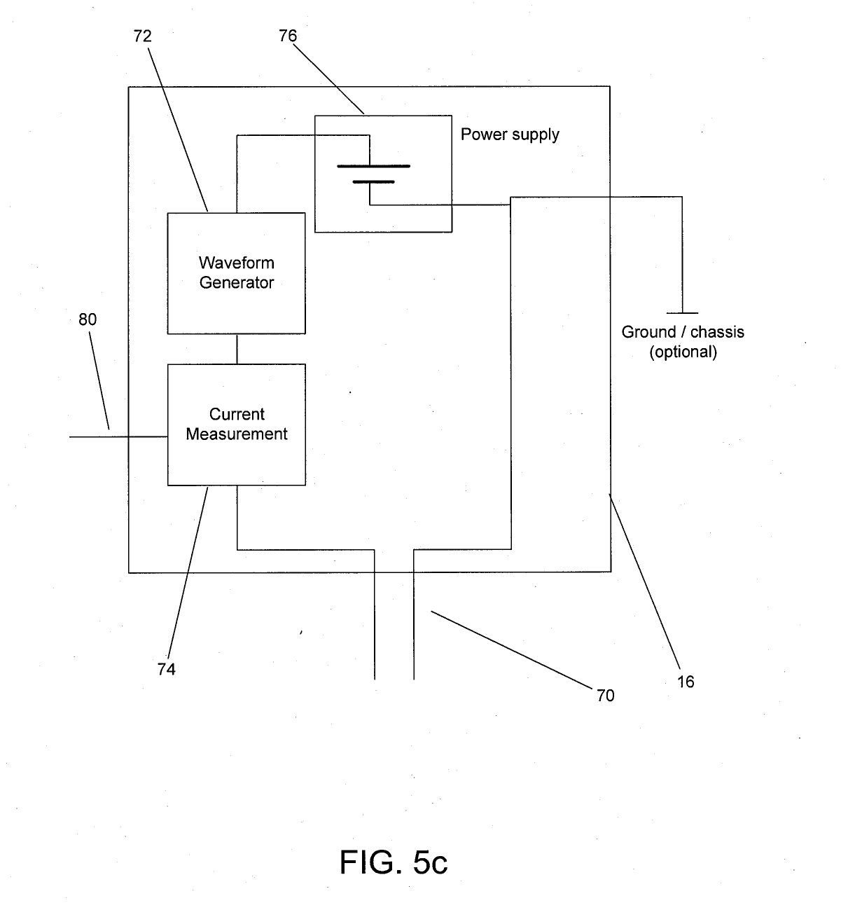

Sensing circuitry for a conductivity sensor in accordance with an embodiment of the invention is shown in FIG. 5a. The sensing circuitry 16 includes a pair of electrical connections 70 that are configured to receive signals from a conductivity sensor. The first electrical connection is connected to a waveform generator 72 and the second electrical connection is connected to a current measurement unit 74. Both the waveform generator 72 and the current measurement unit 74 are connected to a power supply 76 and the current measurement unit 74 is connected to ground. The current measurement unit 74 also includes an output 60 that can be used to provide information to a device such as a microprocessor.

In operation, the waveform generator 72 generates a signal that is provided to a conductivity sensor in a fluid probe and the current measurement unit 74 measures the signal strength of the current in the circuit that is formed by the sensing circuitry 16, the cable, the conductivity sensor and the fluid. In many embodiments, the waveform generator 72 is a square wave with a frequency of between 1 Hz and 100 Hz. In several embodiments, a square wave of 10 Hz that oscillates between +2.5V and −2.5V is applied to one of the electrodes of the conductivity sensor and the other electrode is held at ground potential. In other embodiments, other waveforms including, but not limited to, triangular waves and waveforms having any of a variety of frequencies appropriate to the fluid in which the fluid probe is immersed can be used in the measurement of conductivity.

In many embodiments, the current measurement unit includes a current to voltage converter. The output of the current to voltage converter is provided to an analog to digital converter (ADC) and the digital output of the ADC forms part of the output of the sensing circuitry, which is provided to a microprocessor. The microprocessor can use the signal provided by the current measurement unit and signals provided by other components of the sensing circuitry to analyze the properties of the fluid in which the fluid probe is immersed. In many embodiments, the microprocessor can ascertain the level of the fluid and whether the physical properties of the fluid are changing. When the fluid is a lubricant, the microprocessor can detect early signs of the lubricant deteriorating and warn an operator of the need to replace the lubricant.

As can readily be appreciated, the configuration shown in FIG. 5a is not the only configuration that can be used for providing sensing circuitry in accordance with embodiments of the invention. Embodiments of sensing circuitry that can be used in conjunction with conductivity sensors on a fluid probe are shown in FIG. 5b and FIG. 5c. The configuration shown in FIG. 5b is similar to the configuration shown in FIG. 5a with the exception that the configuration in FIG. 5b does not include a connection between the current measurement unit and ground. The configuration shown in FIG. 5c includes a direct connection between one of the electrical connections and ground and the power supply 76, waveform generator 72 and current measurement unit 74 connected in series with the other electrical connection. The microprocessor applies an algorithm to the ADC values obtained.

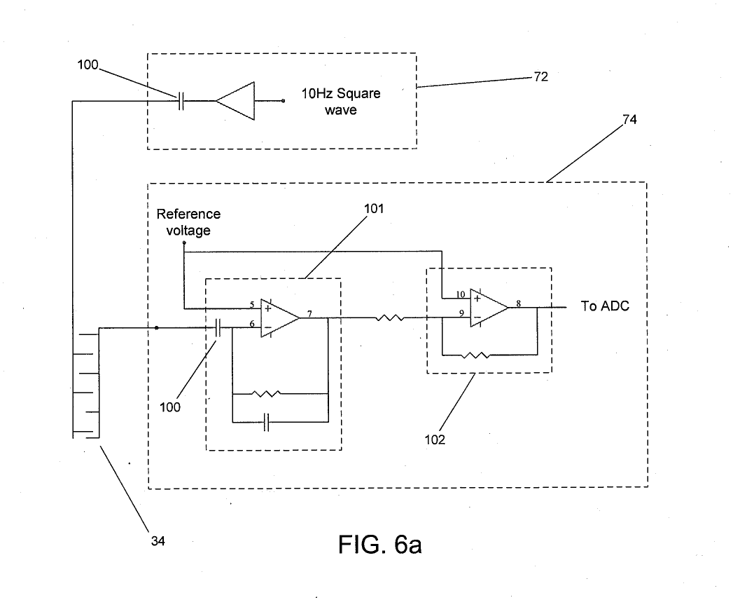

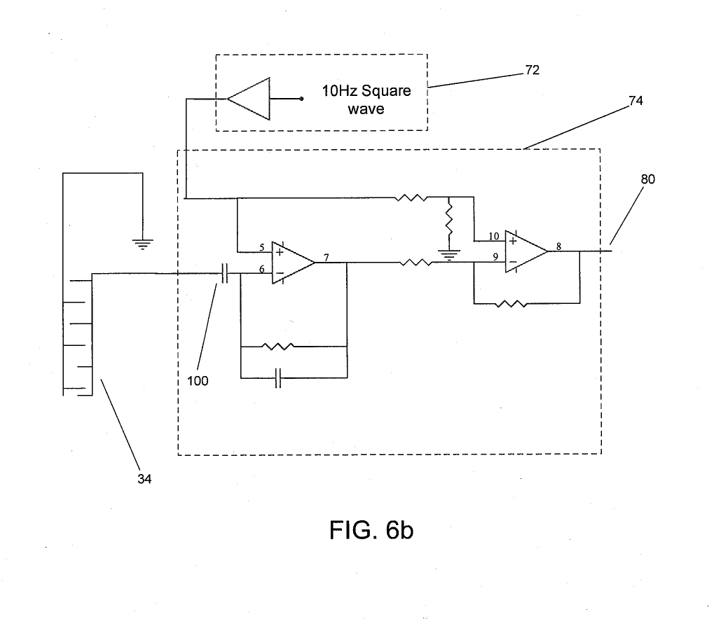

Embodiments of waveform generators and current to voltage converters in accordance with embodiments of the invention are shown in FIGS. 6a and 6b. The embodiment shown in FIG. 6a includes a waveform generator 72 connected to one side of a conductivity sensor 34 and current measurement circuitry 74 connected to the other side of the conductivity sensor. Each input to the conductivity sensor is decoupled with a capacitor 100 to limit direct current flow to the fluid in which the conductivity sensor is immersed. A current signal from the conductivity sensor is provided to a current to voltage converter constructed using a high impedance inverting amplifier 101 and a second inverting amplifier 102. In other embodiments, any of a variety of current to voltage circuits can be used. The output of the current to voltage converter is provided to an ADC as described above. In several embodiments, the ADC forms part of the current measurement circuitry 74. In other embodiments, the ADC can be associated with the microprocessor, such as is the case when a microcontroller is utilized in the fluid sensing system.

A variation on the circuit shown in FIG. 6a in which the waveform generator and the current measurement unit are both connected to one electrode of the conductivity sensor and the other electrode of the conductivity sensor is connected to ground in accordance with an embodiment of the invention is illustrated in FIG. 6b. The current to voltage converter is decoupled from the electrode of the conductivity sensor via a capacitor 100 and is also implemented using a pair of operational amplifiers. In other embodiments, other circuits and circuit configurations can be utilized to obtain current measurements from a conductivity sensor.

Similar circuitry to that described above with respect to the output of conductivity sensors can also be used to condition the output of a temperature sensor for input to a microprocessor. In embodiments where the temperature sensor is a thermistor, a resistance to voltage converter can be used in place of a current voltage converter. In embodiments where the temperature sensor is a thermocouple, the output of the thermocouple is typically a voltage signal.

Each of the outputs of the various sensors on the fluid probe can be provided to a microprocessor for analysis of the fluid in which the fluid probe is immersed. The analysis performed by the microprocessor depends upon the properties of the fluid that are of interest. In a number of embodiments, the fluid probe is immersed in a lubricant and the microprocessor assesses whether the lubricant is close to exceeding its useful lifetime. In other embodiments, the fluid probe is immersed in other fluids and other characteristics of the fluid are detected.

The inputs provided to the microprocessor 18 are analyzed by the microprocessor to evaluate the characteristics of the fluid in which the fluid probe 12 is immersed. The microprocessor can then communicate information to operators using a number of output techniques. In several embodiments, the microprocessor provides output signals via a CAN bus or RS232 connection. The microprocessor can also provide output information via a wireless technology such as Bluetooth or FM digital modulation. The output can also be an analog output such as a voltage or current source. The nature of the microprocessor output is typically dependent upon the nature of the output device used to convey information to an operator. In many embodiments, the output device is a warning light, a gauge, a warning alarm and/or a graphical display. In several embodiments, the output of the microprocessor is provided to another computing device.

Although the sensing circuits shown in each of FIGS. 5a-5c, 6a and 6b are separate from a microprocessor. In many embodiments, the sensing circuitry and microprocessor are implemented using a microcontroller and/or are implemented using a single application specific integrated circuit.

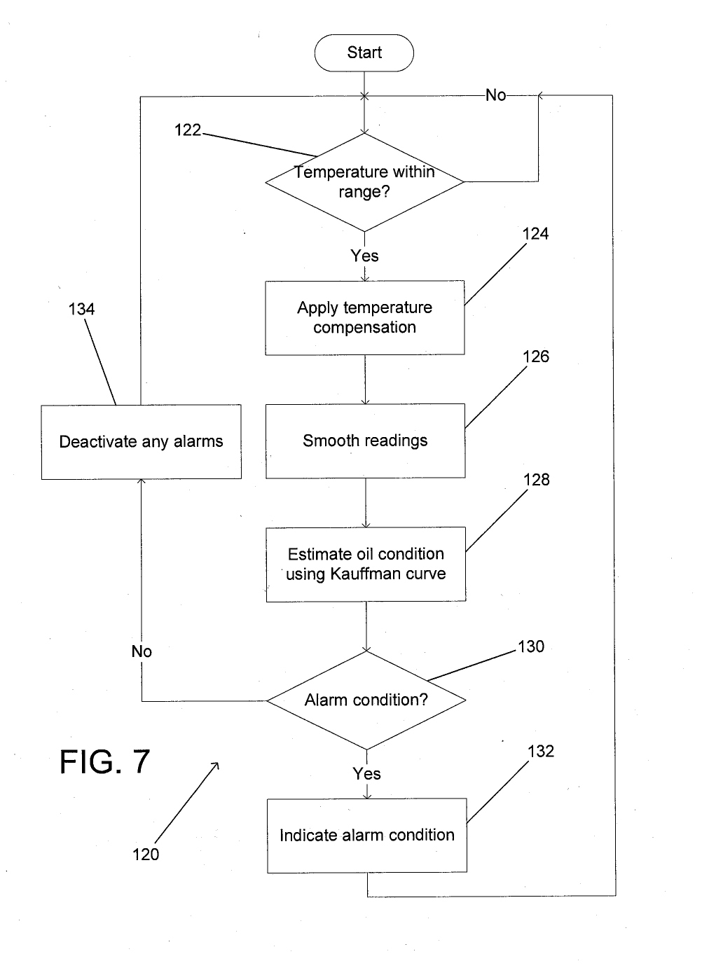

A process in accordance with an embodiment of the invention that can be used for analyzing the properties of a lubricant using the output of at least one conductivity sensor and at least one temperature sensor is shown in FIG. 7. The process 120 commences with a determination (122) as to whether the temperature indicated by the temperature sensor is within an allowable range. In a number of embodiments, the range is chosen to be within the normal operating temperatures of the equipment, and so that the relationship between conductance and lubricant temperature is consistent across an intended range of lubricants. An example of such a range for oils used in automotive engines is 165-230° F.

Upon a determination that the temperature indicated by the temperature sensor is within the desired range, temperature compensation is applied (124) to the conductivity sensor measurements. The temperature compensation removes the effect that the lubricant temperature has on the conductance within the processed range. When the lubricant is oil, the conductance of oil changes significantly with temperature. One compensation technique that can be used is to scale the measured conductance as a function of the oil temperature. The scaling function can be determined in a variety of ways including using a constant function based upon a predetermined conductance to temperature curve for an oil or class of oils, or based upon an adaptive relationship determined from the conductance to temperature relationship measured during recent readings.

The temperature compensated current readings are smoothed (126) to reduce random variation and the smoothed readings are compared (128) to an oil condition curve. In many embodiments, the oil condition curve is a Kauffman curve determined in accordance with the procedures outlined in U.S. Pat. No. 5,933,016 to Kauffman et al. The disclosure of U.S. Pat. No. 5,933,016 to Kauffman et al. is disclosed by reference herein in its entirety. The comparison is discussed further below.

Based upon the comparison, the process determines (130) whether an alarm condition is present. When the oil has exceeded its useful life, an alarm occurs (132). When no alarms are detected, the process continues to monitor the oil.

In embodiments where a fine conductivity sensor and a course conductivity sensor are used, an alarm condition occurs when the ratio of the conductance of the coarse and fine sensors changes. The fine sensor is more sensitive to changes in conductivity due to contaminants (e.g. water) and so an increase in the conductance from the fine sensor that is proportionally greater than that from the coarse sensor is indicative of contamination. The fine sensor also responds more strongly to a film of oil, and so a drop in the conductance from the coarse sensor that is not matched by the fine sensor often indicates that the sensors are not fully immersed in the oil and can trigger another alarm condition. The alarm conditions that can be detected by a process in accordance with an embodiment of the invention are not limited to the alarm conditions described above.

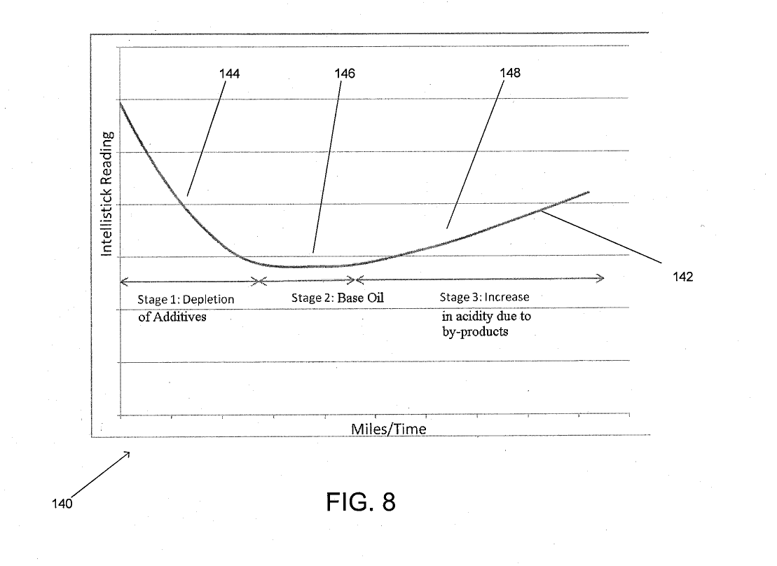

Processes for evaluating the properties of lubricants in accordance with embodiments of the invention often rely on the use of what is known as a Kauffman curve, which is a curve showing the conductivity characteristics of a lubricant as the lubricant deteriorates. A chart including a curve that can be used in a process in accordance with an embodiment of the invention is shown in FIG. 8. The chart 140 plots conductivity readings against time. The plotted relationship 142 shows a decrease in conductivity during a first stage of operation 144. The decrease is typically associated with depletion in lubricant additives. The conductivity remains relatively constant during a second period of time 146 in which the lubricant additives are depleted and the remaining fluid has the characteristics of the base lubricant. During the second stage, mechanical polishing wear can occur. Conductivity increases during a third time period 142. The increase in conductivity during the third time period is largely due to an increase in the acidity of the lubricant caused by oxidation by-products. If the third stage is allowed to continue, the conductivity will start to level out again. As the viscosity of the oil increases during the third state, the severity of engine wear also increases.

The Kauffman curve of a lubricant is typically dependent upon the lubricant type, brand and the operating conditions of the mechanical system. Although the characteristics of Kauffman curves vary depending upon the lubricant, the characteristic turning points of the curve are present with virtually all oils, because oils tend to degrade in a similar fashion. By tracking conductivity of a lubricant with time, the conductivity measurement can be compared to a conductivity curve with characteristics similar to those of the curve shown in FIG. 8 and described above. Based upon the comparison of the measurements over time and key characteristics of the conductivity curve (e.g. detection of turning points), decisions can be made concerning alerting an operator of the need to replace the lubricant.

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

What is claimed is:

1. A fluid probe, comprising:
a printed wiring board substrate on which a first conductivity sensor and a second conductivity sensor are located;
a temperature sensor mounted on the printed wiring board substrate; and
a casing partially encapsulating the printed wiring board substrate so as to leave at least the first and second conductivity sensors exposed.

2. The fluid probe of claim 1, wherein the first and second conductivity sensors each include a pair of electrodes.

3. The fluid probe of claim 2, wherein the spacing of each pair of electrodes is different.

4. The fluid probe of claim 3, wherein each pair of electrodes is an interdigitated pair of electrodes.

5. The fluid probe of claim 1, wherein the first conductivity sensor and the second conductivity sensor are located on opposite sides of the printed wiring board substrate.

6. The fluid probe of claim 1, wherein the temperature sensor is a thermistor.

7. The fluid probe of claim 1, wherein the temperature sensor is a thermocouple.

8. The fluid probe of claim 1, wherein the diameter of the fluid probe is less than 0.35 inches.

9. The fluid probe of claim 1, wherein the first and second conductivity sensors are located in different positions along the length of the printed wiring board substrate.

10. A system for evaluating a fluid, comprising:
a fluid probe, where the fluid probe includes a first conductivity sensor, a second conductivity sensor and a temperature sensor;
signal processing circuitry that receives inputs from the conductivity sensors and the temperature sensor;
a microprocessor configured to receive a pair of current measurements and a temperature measurement from the signal processing circuitry; and
an output device configured to receive signals from the microprocessor.

11. The system of claim 10, wherein the microprocessor is further configured to determine information concerning the fluid using the conductivity measurements and the temperature measurement.

12. The system of claim 11, wherein the microprocessor is further configured to apply a temperature correction to the conductivity measurement.

13. The system of claim 12, wherein the microprocessor is further configured to smooth the corrected conductivity measurements.

14. The system of claim 12, wherein the microprocessor is configured to compare the corrected conductivity measurements over time to a set of characteristics known to be indicative of the deterioration of the fluid.

15. The system of claim 14, wherein the microprocessor is configured to compare the corrected conductivity measurements over time to a Kauffman curve.

16. The system of claim 10, wherein the microprocessor is configured to compare the conductivity measurements of the first and second conductivity sensors.

17. The system of claim 16, wherein:
the first conductivity sensor has a larger pitch than the second conductivity sensor; and
the microprocessor is configured to detect contamination within a fluid by detecting when the ratio of the conductivity measurement of the second conductivity sensor relative to the conductivity measurement of the first conductivity sensor changes.

18. The system of claim 16, wherein:
the second conductivity sensor is located higher on the fluid probe than the first conductivity sensor; and
the microprocessor is configured to determine the level of the fluid by comparing the conductivity measurements of the first conductivity sensor and the second conductivity sensor.

19. A system for detecting degradation of a lubricant, comprising:
a fluid probe including a conductivity sensor; and
signal processing circuitry configured to provide an output from the conductivity sensor to a microprocessor;
wherein the microprocessor is configured to track conductivity measurements over time and to compare the tracked conductivity measurements to information concerning the predetermined conductivity characteristics of a degrading lubricant; and
wherein the microprocessor is configured to generate an alert upon determining that the conductivity measurements indicate that the lubricant is degraded beyond a predetermined threshold.

20. The system of claim 19, wherein:
the fluid probe includes a temperature sensor and the signal processing circuitry is configured to provide an output of the temperature sensor to the microprocessor; and
the microprocessor is further configured to compensate the conductivity measurements based upon the temperature measurements.

21. The system of claim 20, wherein the microprocessor is further configured to smooth the conductivity measurements.

22. The system of claim 21, wherein the microprocessor is configured to compare the tracked conductivity measurements to a Kauffman curve.

23. A method of evaluating a lubricant, comprising:
measuring the conductivity of the lubricant;
recording the conductivity measurements over time;
inspecting the recorded conductivity measurements for predetermined characteristics that are indicative of lubricant deterioration over time; and
determining that the lubricant has exceeded its useful lifetime when the predetermined set of characteristics have been observed in the recorded conductivity measurements.

24. The method of claim 23, further comprising:
measuring temperature; and
compensating the measurement of conductivity for temperature prior to recording the temperature measurement.

25. The method of claim 23, further comprising:
making conductivity measurements using two separate conductivity sensors;
determining the ratio of the conductivity measurements of the two sensors; and
detecting contamination of the lubricant based upon a change in the ratio of the conductivity measurements of the two sensors.

26. The method of claim 23, further comprising:
making conductivity measurements from two separate conductivity sensors;
comparing the conductivity measurements from two conductivity sensors; and
determining the level of the lubricant based upon the comparison.

27. The method of claim 23, wherein the predetermined characteristics include a period of decreasing conductivity followed by at least one turning point.
